(19) United States
(12) Patent Application Publication
(10) Pub. No.: US 2010/0053532 A1
(43) Pub. Date: Mar. 4, 2010

(54) Liquid crystal display having touch detecting structure

(75) Inventor: Hui-Lung Lai, Tainan County (TW)

Correspondence Address: BACON & THOMAS, PLLC, 625 SLATERS LANE, FOURTH FLOOR, ALEXANDRIA, VA, 22314-1176, US

(73) Assignee: CHI HSIN ELECTRONICS CORP., Tainan County (TW)

(21) Appl. No.: 12/230,204

(22) Filed: Aug. 26, 2008

(51) Int. Cl. G02F 1/1345; G06F 3/045

(52) U.S. Cl. 349/151; 345/174

(57) ABSTRACT

A liquid crystal display having a touch detecting structure includes an upper substrate, a lower substrate and a liquid crystal layer therebetween. A plurality of first electrodes, a plurality of second electrodes, and an insulating layer, which insulates the first and second electrodes, are provided between the liquid crystal layer and the lower substrate. The insulating layer is provided with a plurality of through holes associated with the first and second electrodes. An auxiliary pressing unit is between the upper substrate and the second electrodes, which includes a plurality of insulating protrusions above the through holes. When the liquid crystal display is pressed, the protrusion under the pressure will push the second electrode to have the second contact area contacting the first contact area that may increase the accuracy of touching.

### BACKGROUND OF THE INVENTION

1. Field of the Invention

The present invention relates to a liquid crystal display and more particularly, to a liquid crystal display having a touch detecting structure.

2. Description of the Related Art

In present days, the application of liquid crystal displays (LCDs) is broad. The LCDs are made lighter, thinner, and smaller. Beside the enhancement of displaying quality, the design for an easier operation is another important issue. For this, the LCDs equipped with touch function are presented to improve the conventional LCDs operated by keys.

As shown in FIG. 1, such LCD 1 includes a display unit 2 and a touch unit 3. The display unit 2 includes a upper substrate 2a, a lower substrate 2b and a liquid crystal layer 2c between the upper and lower substrates 2a, 2b. Besides, a color filter layer 2d is provided between the upper substrate 2a and the liquid crystal layer 2c for color displaying. The touch unit 3 is stacked on the display unit 2 facing the users to be operated by the users. The touch unit 3, however, is an independent device to be connected to the display unit 2 to complete the LCD, and it has two transparent boards 3a, 3b that the conventional LCD is thicker and heavier. In addition, the transparent boards 3a, 3b are the last two elements that light traveling out of the LCD that will make the light output efficiency decreasing and affect the displaying quality. Again, the touch unit 3 is attached on the display unit 2 that the attaching step will enlarge the assembling process's loading.

### SUMMARY OF THE INVENTION

The primary objective of the present invention is to provide a liquid crystal display having a touch detecting structure, which the touch detecting structure is built in the display to enhance the optical displaying performance and to decrease the thickness and weight of the liquid crystal display.

To achieve the objective of the present invention, a liquid crystal display having a touch detecting structure includes an upper substrate and a lower substrate. A liquid crystal layer and the touch detecting structure are provided between the upper substrate and the lower substrate. The touch detecting structure, which is provided between the liquid crystal layer and the lower substrate, includes a plurality of first electrodes, an insulating layer, and a plurality of second electrodes. The first electrodes are extended along a first direction. Each of the first electrodes has at least a first contact area. The second electrodes are extended along a second direction crossing the first direction. Each of the second electrodes has contact areas associated with the through holes, and each of the contact areas keeps a predetermined distance from the corresponding first contact area of the first electrode. The insulating layer, which electrically insulates the first electrodes and the second electrodes, has a plurality of through holes associated with the first contact areas of the first electrodes respectively. The second contact areas do not mask the entire through holes.

Besides, the present invention further provides an auxiliary pressing unit between the upper substrate and the second electrodes, which includes a plurality of insulating protrusions above the through holes. When a surface of the liquid crystal display is pressed, the protrusion under the pressure will push the second electrode to have the second contact area contacting the first contact area that may increase the accuracy of touching.

### BRIEF DESCRIPTION OF THE DRAWINGS

FIG. 1 is a sectional view of the conventional LCD having touch function;

FIG. 2 is a sectional view in a part of a preferred embodiment of the present invention;

FIG. 3 is a sectional view along the 3-3 line of FIG. 2;

FIG. 4 is a sectional view along the 4-4 line of FIG. 2;

FIG. 5 is similar to FIG. 3, showing the vertical second electrode;

FIG. 6 is similar to FIG. 3, showing the second electrode having the recess portion and the protrusion corresponding to the through hole;

FIG. 7 is similar to FIG. 3, showing the height of the first protrusion of the auxiliary pressing unit is greater than a half of the thickness of the liquid crystal layer;

FIG. 8 is similar to FIG. 3, showing the height of the second protrusion of the auxiliary pressing unit is greater than a half of the thickness of the liquid crystal layer;

FIG. 9 is similar to FIG. 4, showing the LCD having a third insulating layer covering all of the second electrodes;

FIG. 10 is similar to FIG. 2, showing plural electrodes electrically connected together and then connected to the system terminal of the LCD;

FIG. 11 is similar to FIG. 2, showing the odd electrodes connected to the system terminal of the LCD; and

FIG. 12 is similar to FIG. 4, showing the contact area of the second electrode wider than the through hole.

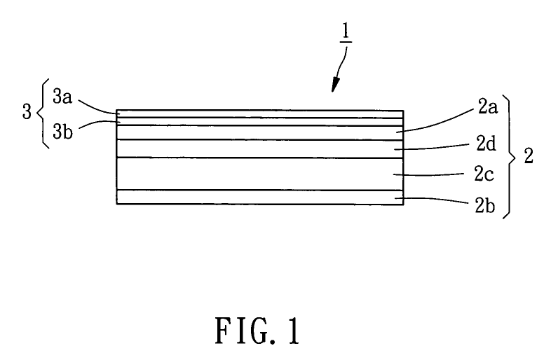

### DETAILED DESCRIPTION OF THE INVENTION

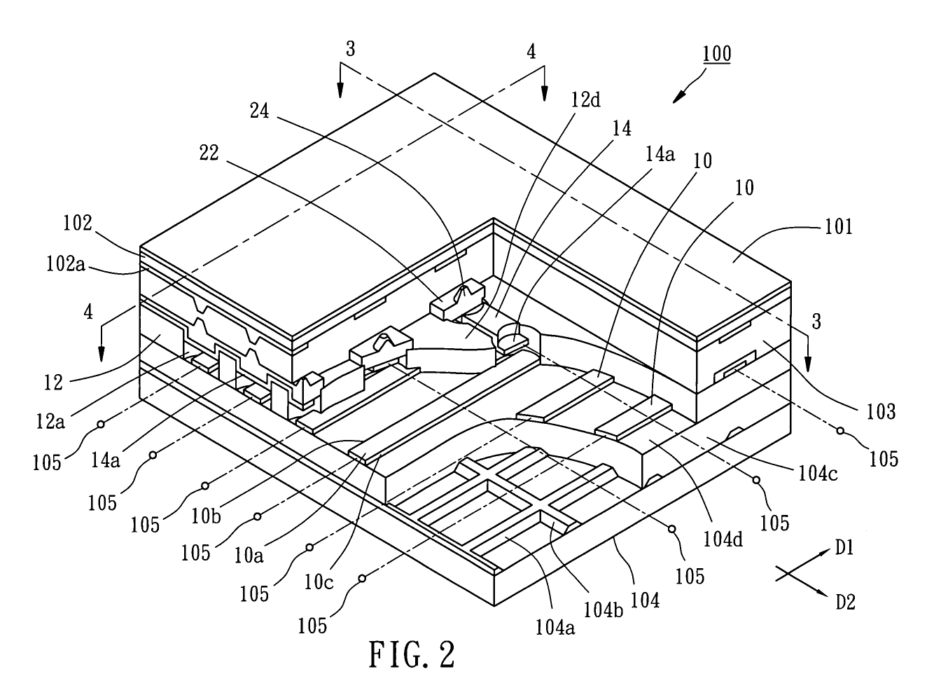

FIGS. 2-4 show a liquid crystal display (LCD) 100 equipped with a touch detecting structure of the preferred embodiment of the present invention, which includes an upper substrate 101, a color filter layer 102, a liquid crystal layer 103, and a lower substrate 104. The color filter layer 102 includes a black matrix 102a for separation of plural red, green, and blue light filter units. The lower substrate 104 includes a thin film transistor matrix substrate having plural data lines 104a and scan lines 104b along a first direction D1 and a second direction D2 respectively and a first insulating layer 104c covering the data lines 104a and the scan lines 104b. The first direction D1 is orthogonal to the second direction D2. The first insulating layer 104c has a first surface 104d. The LCD 100 of the present embodiment includes a system terminal 105 to detect and determine the location of the pressure on the touch detecting structure.

The touch detecting structure of the present embodiment includes plural first electrodes 10, an insulating layer 12, plural second electrodes 14, and an auxiliary pressing unit 20.

The first electrodes 10 are provided on the first surface 104d of the first insulating layer and are along the first direction in parallel. The first electrodes 10 are projected from the first surface 104d. In the present embodiment, each of the first electrodes 10 has a first contact area 10a on a top thereof and two long lateral sides adjacent to the top. The first electrodes 10 are electrically connected to the system terminal 105.

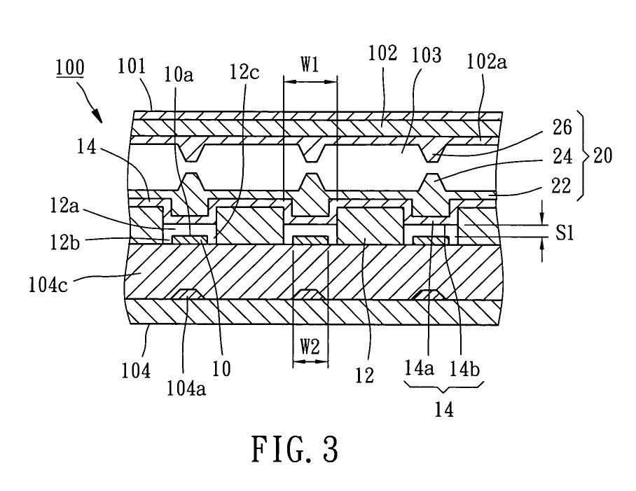

The insulating layer 12, which is made of an insulating material and is provided on the first insulating layer 104c to cover the first electrodes 10, has through holes 12a with the same diameter, plural of which are associated with one first electrode 10. Referring to FIG. 3, a diameter W1 of each through hole 12a along the second direction D2 is greater than a width W2 of the corresponding first contact area 10a of the first electrode 10 along the second direction D2. There are gaps 12b, 12c between an inner sidewall of each through hole 12a and the long lateral sides 10b, 10c of the corresponding first electrode 10. The insulating layer 12 has a second surface 12d facing the liquid crystal layer 103.

Before the second electrodes 14 are made, insulating support pads (not shown) are provided in the through holes 12a first. The support pads cover the first electrodes 10. The support pads are common elements in this art, so we do not describe the detail here. Next, a metal foil is deposited on the second surface 12d of the insulating layer 12 for photoresistor coating, exposure, development, and etching steps that the parallel second electrodes 14 are made on the second surface 12d and along the second direction D2. The second electrodes 14 are electrically connected to the system terminal 105.

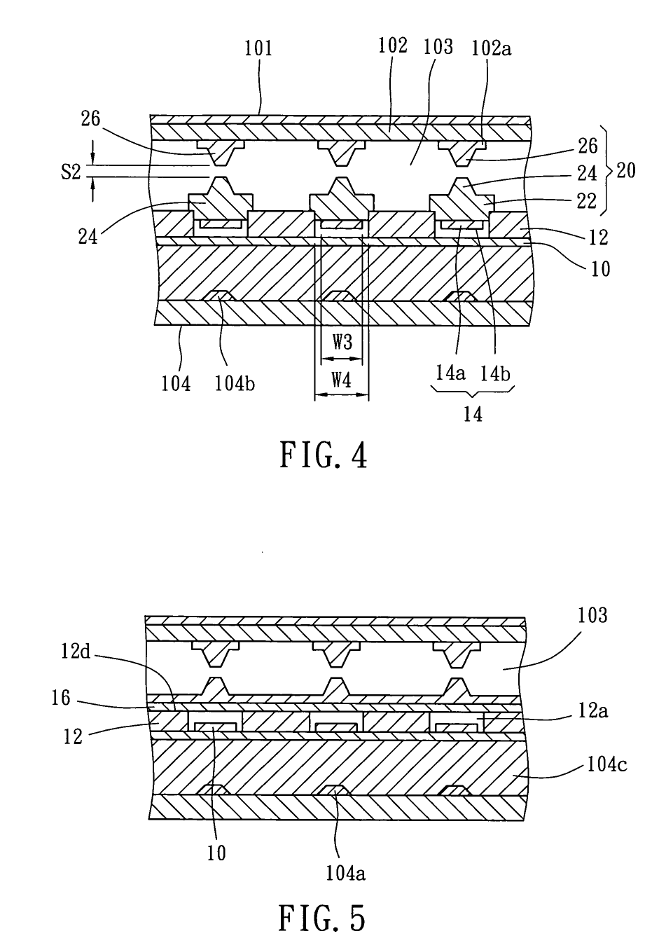

In above processes, the support pads are lower than the second surface 12d of the insulating layer 12 that a U-shaped contact terminal 14a is formed on each of the second electrodes 14 corresponding to the through holes 12a respectively. As shown in FIG. 4, a diameter W4 of each of the through holes 12a of the insulating layer 12 along the first direction D1 is greater than a width W3 of the corresponding contact terminal 14a of the second electrode 12 along the first direction D1. This designation is convenient for removal of the support pads. After the support pads are removed, the contact terminals 14a will be suspended and form second contact areas 14b on sides thereof facing the first electrodes 10 respectively. There is a distance S1 between each of a pair of the first contact area 10a and the second contact area 14b.

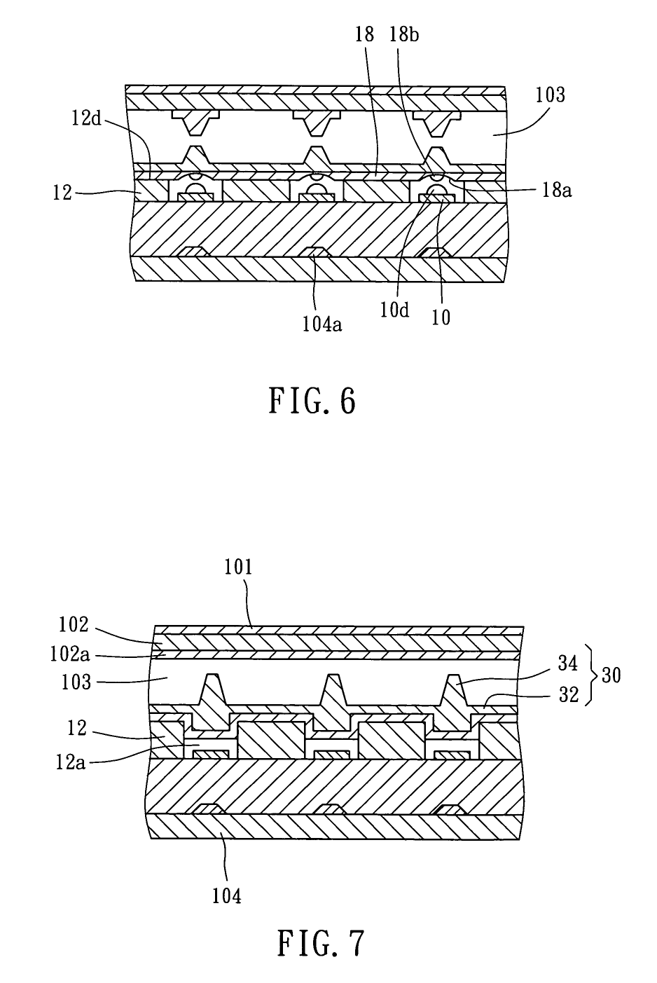

It is mentioned that the support pads may be even with the second surface 12d of the insulating layer 12 that will form plural vertical second electrodes 16 as shown in FIG. 5. When the support pads are higher than the second surface 12d of the insulating layer 12, it will get plural second electrodes 18 having recess portions 18a as shown in FIG. 6. To enhance the contact of electrodes, it may provide a protrusion 18b in the recess portion 18a, and the first electrode 10 may be provided with a protrusion 10d also.

The auxiliary pressing unit 20 includes a plurality of insulating ribs 22, first protrusions 24, and second protrusions 26. Each of the insulating ribs 24 totally covers the corresponding second electrode 14. The first protrusions 24 are projected from the insulating ribs 22 and enter the liquid crystal layer 103. Each of the first protrusions 24 is right above the corresponding through hole 14a. The second protrusions 26 are connected to the black matrix 102a and extended toward the first protrusions 24 to enter the liquid crystal layer 103. Heights of the first protrusions 24 and the second protrusions 26 is ⅓ of a thickness of the liquid crystal layer 103 so that a distance S2 is between first protrusions 24 and the second protrusions 26 respectively.

When a pressure is exerted on the LCD 100 by finger or by pen, the second protrusion 26 under the pressure will be moved downward and touches the first protrusion 24 thereunder, and the first protrusion 24 will press the second electrode 14 and make it deformed that a distal end of the protrusion 14a of the second electrode 14 will touch the first contact area 10a of the first electrode 10 to generate a resistance effect. In the same time, the system terminal 105 of the LED 100 will determine the location of the pressure by a change of a current for the following operation.

The present invention provides the touch detecting structure built in the LCD 100 that the thickness and weight of the LCD 100 of the present invention is less than that of the conventional LCD equipped with touch panel, and the present invention has a better optical displaying performance. The auxiliary pressing unit 20 may increase the accuracy of touching.

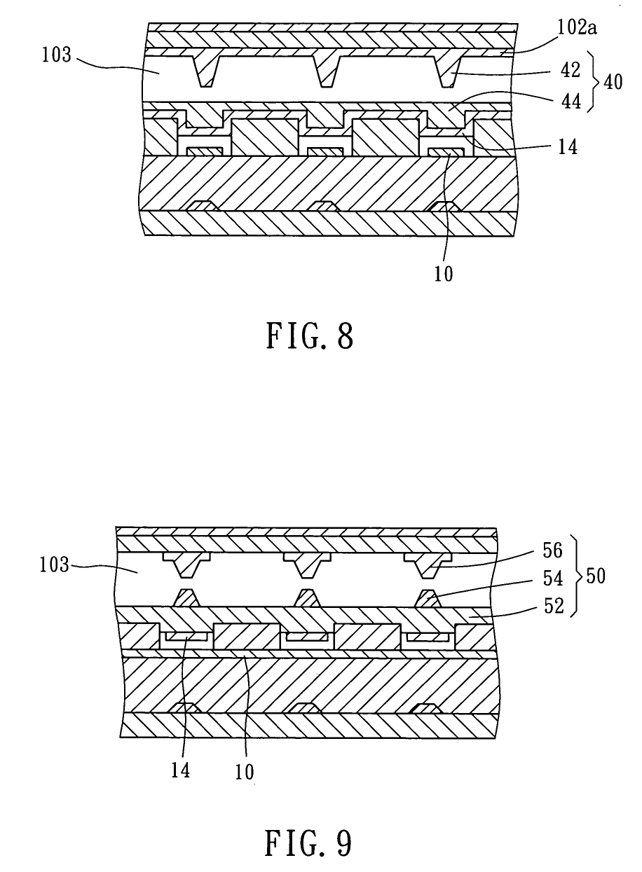

It is mentioned that there are several ways other than the auxiliary pressing unit 20 to increase the accuracy of touching. For example, FIG. 7 shows an auxiliary pressing unit 30, which has no the second protrusion, having first protrusions 34 connected to an insulating rib 32, each of which has a height greater than a half of the thickness of the liquid crystal layer 103. FIG. 8 shows an auxiliary pressing unit 40, which has no the first protrusion 24 as shown in FIG. 3, only having second protrusions 42 connected to the black matrix 102a and insulating ribs 44 covering the second electrodes 14, wherein heights of the second protrusions 42 are greater than a half of the thickness of the liquid crystal layer 103. FIG. 9 shows an auxiliary pressing unit 50, which provides a third insulating layer 52 covering the second electrodes 14 to replace the insulating ribs 52. The auxiliary pressing unit 50 includes first protrusions 54 and second protrusions 56 as above. All of the auxiliary pressing units as described above may increase the accuracy of touching.

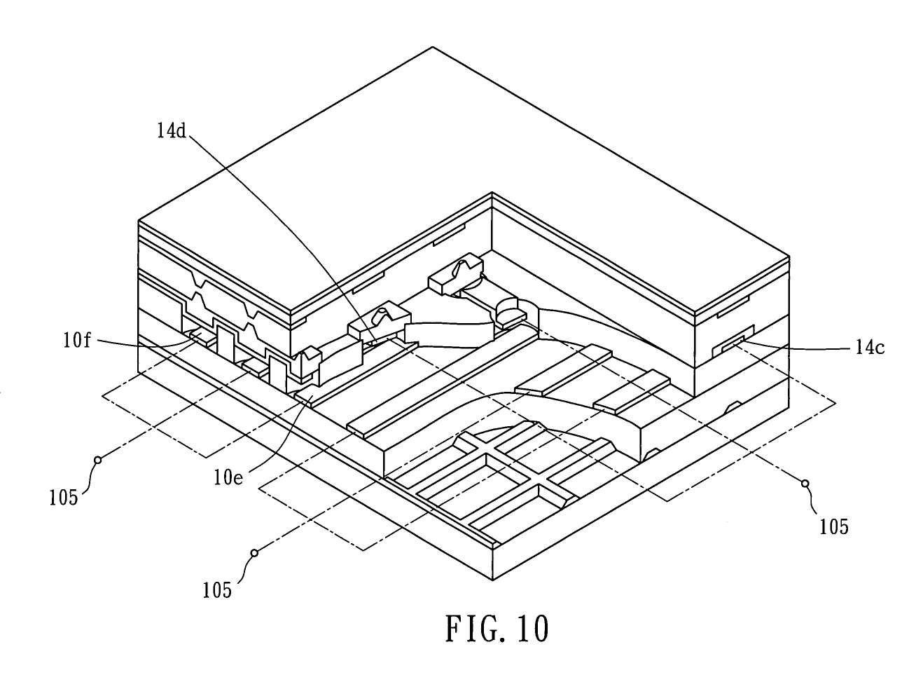

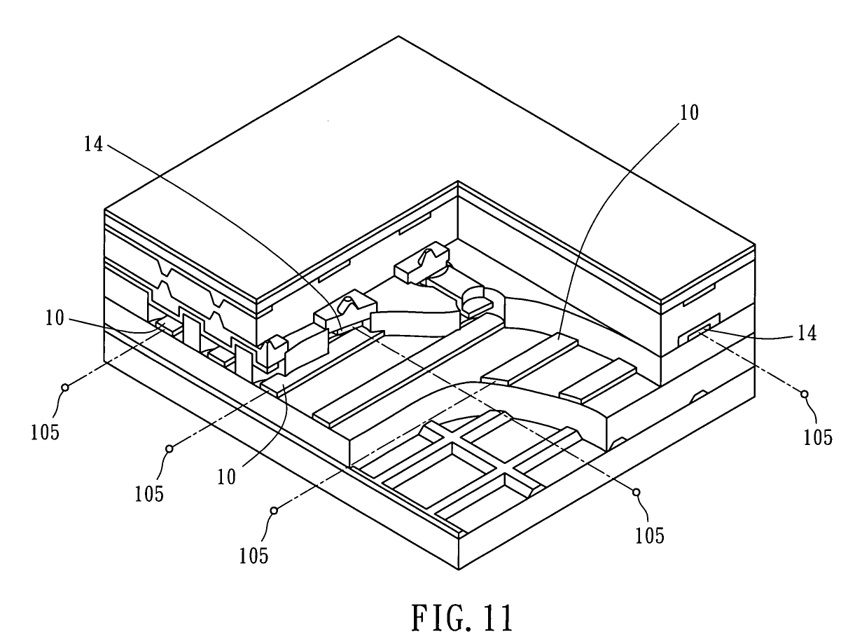

It is mentioned that each of the first electrodes 10 and the second electrodes 14 are electrically connected to the system terminal 110 respectively, beside that the first electrodes 10 and the second electrodes 14 may be divided into several groups to be electrically connected to the system terminal 105 respectively, as shown in FIG. 10. The electrodes in each group are electrically connected together first, and then connected to the system terminal 105. In each group, a distance from the first to the last of the first electrodes 10e, 10f (or the second electrodes 14c, 14d ) is less than 0.7 cm. This is because that the electrodes are very fine, and it is about 0.7 cm when a tip of finger touches the electrodes, so that the groups may provide the system terminal 107 sensing the correct touching position. In addition, the connection of the electrodes and the system terminal 105 may be done as shown in FIG. 11 which only odd electrodes are connected to the system terminal 105. There may be two or more electrodes not connected to the system terminal 105 between the electrodes connected to system terminal 105. However, a distance of the distribution of the electrodes should be less than 0.7 cm for the correct location sensing. Referring to FIG. 2, a distance between the neighboring first electrodes 10 and the neighboring second electrodes 14 should be less than 0.7 cm also for the condition of touching by finger. On contrary, in the condition of touching by pen, the distance between the neighboring first electrodes 10 (or the neighboring second electrodes 14) should be narrower.

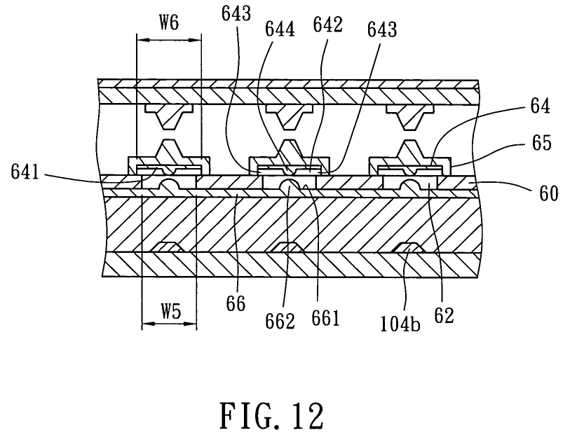

In the embodiments as described above, widths of the second contact areas of the second electrodes along the first direction are less than that of the through holes of the insulating layer along the first direction. This character makes it easier to clean the support pads made of insulating material. There are some other ways to achieve the above objective. For example, referring to FIG. 12, widths W5 of through holes 62 of insulating layer 60 along the first direction D1 are less than widths W6 of contact areas 641 of second electrodes 64 along the first direction D1. Furthermore, each of the second electrodes 64 has a recess portion 642 associated with the through holes 62 and two gaps 643 on opposite sides of the recess portion 642 communicated with outside that also may help the step of cleaning the support pads. The second electrode 64 is provided with a protrusion 644 on a bottom side of the recess portion 642, and the first electrode 66 is provided with a protrusion 662 on the first contact area 641 to enhance the contact of the electrodes.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A liquid crystal display having a touch detecting structure, comprising:
an upper substrate;
a lower substrate;
a liquid crystal layer between said upper substrate and said lower substrate;
a plurality of first electrodes between said lower substrate and said liquid crystal layer and substantially extended along a first direction, wherein some of said first electrodes have at least a first contact area respectively;
an insulating layer, which is provided between said first electrodes and said liquid crystal layer, having a plurality of through holes associated with said first contact areas of said first electrodes respectively; and
a plurality of second electrodes, which is provided between said insulating layer and said liquid crystal layer and along a second direction crossing said first direction, wherein each of said second electrodes has contact terminals associated with said through holes, and each of said contact terminals, which does not mask said entire through hole, has a second contact area keeping a predetermined distance from said corresponding first contact area of said first electrode.

2. The liquid crystal display having the touch detecting structure as claimed in claim 1, wherein said second electrodes are provided on said insulating layer, and widths of said through holes of said insulating layer along said first direction are greater than that of said second contact areas of said second electrodes.

3. The liquid crystal display having the touch detecting structure as claimed in claim 2, wherein said contact terminals of said second electrodes are received in said through holes of said insulating layer respectively.

4. The liquid crystal display having the touch detecting structure as claimed in claim 2, wherein each of said second electrodes has a recess portion on said contact terminal associated with said through hole.

5. The liquid crystal display having the touch detecting structure as claimed in claim 4, wherein each of said second electrodes has a protrusion on a bottom side of said recess portion thereof.

6. The liquid crystal display having the touch detecting structure as claimed in claim 5, wherein each of said first electrodes has a protrusion on said first contact area associated with said protrusions of said second electrodes respectively.

7. The liquid crystal display having the touch detecting structure as claimed in claim 1, wherein said second electrodes are provided on said insulating layer has a top side, and widths of said through holes of said insulating layer along said first direction are less than that of said second contact areas of said second electrodes along said first direction, and each of said second electrodes has at least a gap communicated with said through hole of said insulating layer.

8. The liquid crystal display having the touch detecting structure as claimed in claim 7, wherein each of said second electrodes has a recess portion on a side facing said through hole and said gap beside said recess portion.

9. The liquid crystal display having the touch detecting structure as claimed in claim 8, wherein each of said second electrodes has a protrusion on said first contact area associated with protrusions said first contact areas of said first electrodes respectively.

10. The liquid crystal display having the touch detecting structure as claimed in claim 1, wherein said first direction is orthogonal to said second direction, and widths of said through holes of said insulating layer along said second direction are less than that of said first contact areas of said first electrodes along said second direction.

11. The liquid crystal display having the touch detecting structure as claimed in claim 10, all of said through holes of said insulating layer substantially have the same diameter.

12. The liquid crystal display having the touch detecting structure as claimed in claim 11, wherein said lower substrate has a first insulating layer having a first surface, on which said first electrodes are provided and projected thereform, and there is a gap between each of said long lateral sides of said first electrodes and a sidewall of each of said through holes of said insulating layer respectively.

13. The liquid crystal display having the touch detecting structure as claimed in claim 1, further comprising an auxiliary pressing unit including a plurality of insulating protrusions between said upper substrate and said second electrodes and above said through holes respectively.

14. The liquid crystal display having the touch detecting structure as claimed in claim 13, wherein said auxiliary pressing unit further includes a plurality of insulating ribs covering said second electrodes respectively, and said protrusions have a plurality of first protrusions connected to side insulating ribs and extended toward said upper substrate to enter said liquid crystal layer.

15. The liquid crystal display having the touch detecting structure as claimed in claim 14, wherein heights of said first protrusions are greater than a half of a thickness of said liquid crystal layer.

16. The liquid crystal display having the touch detecting structure as claimed in claim 14, further comprising a color filter layer, which has a black matrix, between said upper substrate and said liquid crystal layer, wherein said protrusions of said auxiliary pressing unit further include a plurality of second protrusions extended toward said first protrusion to enter said liquid crystal layer.

17. The liquid crystal display having the touch detecting structure as claimed in claim 16, wherein heights of said first protrusions and said second protrusions is greater than ⅓ of a thickness of said liquid crystal layer.

18. The liquid crystal display having the touch detecting structure as claimed in claim 13, further comprising a color filter layer, which has a black matrix, between said upper substrate and said liquid crystal layer, wherein said protrusions of said auxiliary pressing unit further include a plurality of second protrusions extended toward said lower substrate to enter said liquid crystal layer, and heights of said second protrusions are greater than a half of a thickness of said liquid crystal layer.

19. The liquid crystal display having the touch detecting structure as claimed in claim 13, further comprising a third insulating layer covering said second electrodes, wherein said protrusions of said auxiliary pressing unit are provided on said third insulating layer.

20. The liquid crystal display having the touch detecting structure as claimed in claim 1, wherein said first electrodes are divided into several groups, in each of which a distance from the first to the last of said first electrodes is less than or identical to 0.7 cm.

21. The liquid crystal display having the touch detecting structure as claimed in claim 1, wherein said second electrodes are divided into several groups, in each of which a distance from the first to the last of said second electrodes is less than or identical to 0.7 cm.

22. The liquid crystal display having the touch detecting structure as claimed in claim 1, wherein a distance between said neighboring first electrodes is less than or identical to 0.7 cm.

23. The liquid crystal display having the touch detecting structure as claimed in claim 1, wherein a distance between said neighboring second electrodes is less than or identical to 0.7 cm.

24. The liquid crystal display having the touch detecting structure as claimed in claim 1, wherein said first electrodes are divided into several groups, in each of which said first electrodes are electrically connected together, and a distance from the first to the last of said first electrodes is less than or identical to 0.7 cm.

25. The liquid crystal display having the touch detecting structure as claimed in claim 1, wherein said second electrodes are divided into several groups, in each of which said second electrodes are electrically connected together, and a distance from the first to the last of said second electrodes is less than or identical to 0.7 cm.
